(19) United States
(12) Patent Application Publication
(10) Pub. No.: US 2026/0183172 A1
(43) Pub. Date: Jul. 2, 2026

(54) MIRROR-SYNCHRONIZED REHABILITATION SYSTEM AND METHOD FOR UPPER LIMBS

(71) Applicant: INDUSTRIAL TECHNOLOGY RESEARCH INSTITUTE, HSINCHU (TW)

(72) Inventors: Tsung-Hua LI, Hsinchu City (TW); Ming-Chieh TSAI, Hsinchu County (TW); Yoong Kee SEK, Hsinchu City (TW)

(21) Appl. No.: 19/305,816

(22) Filed: Aug. 21, 2025

Related U.S. Application Data
(60) Provisional application No. 63/739,684, filed on Dec. 30, 2024.

(30) Foreign Application Priority Data
May 1, 2025 (TW) 114116488

(51) Int. Cl. A61H 1/02

(52) U.S. Cl. CPC A61H 1/0285; A61H 2201/1276; A61H 2201/1635; A61H 2201/5043; A61H 2201/5048; A61H 2201/5064; A61H 2201/5092

(57) ABSTRACT

A mirror-synchronized rehabilitation system for upper limbs includes a display, an audio device, a gripping mechanism, an image capture device, a rehabilitation database, and a processor. The gripping mechanism includes mirror-synchronized first and second grips, and is configured to enable a user to grasp and move with hands respectively according to rehabilitation instruction image and a tempo of music. The rehabilitation instruction module of the processor is configured to generate the rehabilitation instruction image and the music according to the rehabilitation data. The analysis feedback module of the processor is configured to analyze the motion image to calculate a motion stability of the hands, and the tempo of the music is adjusted by the rehabilitation instruction module according to the motion stability so that the user moves the first and second grips according to the rehabilitation instruction image and the adjusted tempo of the music.

### RELATED APPLICATIONS

This application claims priority to U.S. Provisional Ser. No. 63/739,684, filed Dec. 30, 2024 and Taiwan Application Serial Number 114116488, filed May 1, 2025, which are herein incorporated by reference in their entirety.

### BACKGROUND

### Technical Field

The technical field relates to a mirror-synchronized rehabilitation system and method for upper limbs, particularly relates to a mirror-synchronized rehabilitation system and method for upper limbs for rehabilitation following images and music.

### Description of Related Art

When facing a stroke or movement disorder, rehabilitation is required to restore the limbs' motor ability. However, in general, during the rehabilitation process, the rehabilitator needs to go through a large amount of repetitive movement training, which may easily make the person feel bored or even lose motivation for rehabilitation. Therefore, if the challenge and fun of rehabilitation may be increased, it will help the person increase his or her stickiness to rehabilitation exercises. On the other hand, since most rehabilitation exercises lack quantitative evaluation tools, it is easy to make it difficult to immediately evaluate the effectiveness of rehabilitation. It is also difficult to make timely adjustments in the planning of rehabilitation exercises according to the person's rehabilitation condition. If the difficulty of rehabilitation cannot be adjusted according to the person's condition, the rehabilitation effect is likely to be reduced. Therefore, there is a need for a rehabilitation method that may enable the person to be willing to perform rehabilitation regularly and may be adjusted immediately according to the rehabilitation condition.

### SUMMARY

The disclosure provides a mirror-synchronized rehabilitation system for upper limbs. The mirror-synchronized rehabilitation system for upper limbs includes a display, an audio device, a gripping mechanism, an image capture device, a rehabilitation database, and a processor. The display is configured to display a rehabilitation instruction image. The audio device is configured to play music. The gripping mechanism includes mirror-synchronized first and second grips, and is configured to enable a user to grasp and move with hands respectively according to the rehabilitation instruction image and a tempo of the music. The image capture device is configured to capture a motion image of the hands. The rehabilitation database is configured to store rehabilitation data. The processor is communicatively connected to the display, the audio device, the image capture device, and the rehabilitation database, and includes a rehabilitation instruction module and an analysis feedback module. The rehabilitation instruction module is used for generating the rehabilitation instruction image and the music according to the rehabilitation data. The analysis feedback module is configured to analyze the motion image to calculate a motion stability of the hands, and the tempo of the music is adjusted by the rehabilitation instruction module according to the motion stability so that the user moves the first and second grips according to the rehabilitation instruction image and the tempo of the music adjusted.

The disclosure also provides a mirror-synchronized rehabilitation method for upper limbs, including: generating the rehabilitation instruction image and the music according to the rehabilitation data with a processor; displaying a rehabilitation instruction image with a display and playing music with an audio device; capturing a motion image with an image capture device, wherein the motion image comprises that a user grasp and move mirror-synchronized first and second grips, comprised in a gripping mechanism, with hands respectively according to the rehabilitation instruction image and a tempo of the music; analyzing the motion image to calculate a motion stability of the hands with the processor; and adjusting the tempo of the music according to the motion stability with the processor so that the user moves the first and second grips according to the rehabilitation instruction image and the tempo of the music adjusted.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIG. 1 is a schematic diagram of a mirror-synchronized rehabilitation system for upper limbs in accordance with some embodiments of the present disclosure.

FIG. 2 is a flowchart of a mirror-synchronized rehabilitation method for upper limbs in accordance with some embodiments of the present disclosure.

FIG. 3 is a schematic diagram of a rehabilitation instruction image in accordance with some embodiments of the present disclosure.

FIG. 4 is a schematic diagram of performing a skeleton detection on a motion image with a skeleton detection model in accordance with some embodiments of the present disclosure.

FIG. 5 is a schematic diagram of a rehabilitation instruction image in accordance with some embodiments of the present disclosure.

### DETAILED DESCRIPTION

The following exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

The term “mirror-synchronized” and “mirror synchronization” refer to two objects performing similar or identical movements in a left-right symmetrical manner at the same time.

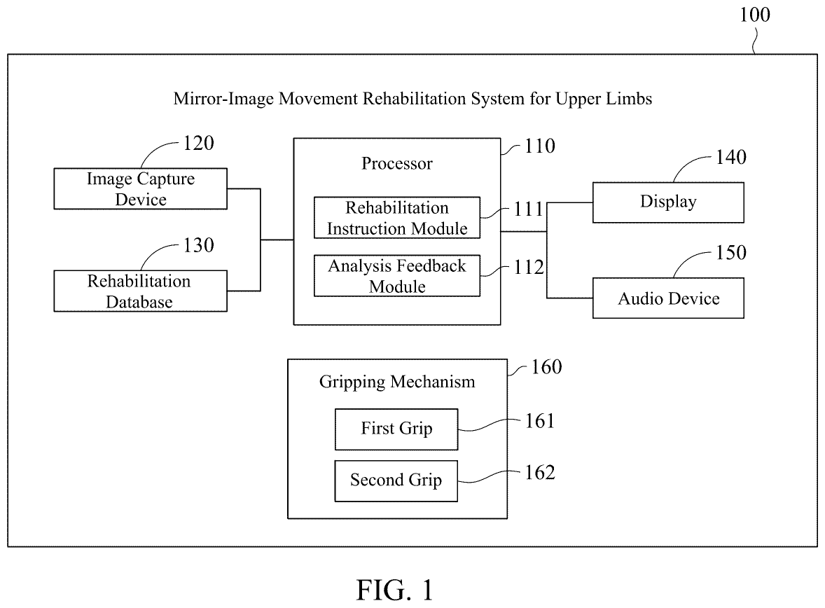

FIG. 1 is a schematic diagram of a mirror-synchronized rehabilitation system for upper limbs 100 in accordance with some embodiments of the present disclosure. As shown in FIG. 1, the mirror-synchronized rehabilitation system for upper limbs 100 includes a processor 110, in which the processor 110 is communicatively connected to an image capture device 120, a rehabilitation database 130, a display 140, and an audio device 150 respectively, and the processor 110 includes a rehabilitation instruction module 111 and an analysis feedback module 112. In addition, the mirror-synchronized rehabilitation system for upper limbs 100 also includes a gripping mechanism 160, in which the gripping mechanism 160 includes a first grip 161 and a second grip 162.

In an embodiment, the first grip 161 and the second grip 162 of the gripping mechanism 160 are mirror-synchronized. For example, in the case of the first grip 161 located on the left side of the gripping mechanism 160 and the second grip 162 located on the right side of the gripping mechanism 160, when the first grip 161 is driven by a user to move to the upper-left, the second grip 162 simultaneously mirrors and moves to the upper-right. When the second grip 162 is driven by a user to move to the lower-left, the first grip 161 simultaneously mirrors and moves to the lower-right. Therefore, when user's hands grasp the first grip 161 and the second grip 162 with the left hand and the right hand respectively, the left hand may move the first grip 161 to drive the second grip 162, so that the right hand grasping the second grip 162 is mirror-synchronized. The right hand may move the second grip 162 to drive the first grip 161, so that the left hand grasping the first grip 161 is mirror-synchronized.

The image capture device 120 is installed at a position where the hands grasping the first grip 161 and the second grip 162 may be capture, that is, the shooting range of the image capture device 120 covers the entire range of the hands grasping the first grip 161 and the second grip 162 and moving, to capture the image of the hands during the movement. Here, the image may be a dynamic image or static images, which is not limited thereto as long as it may be captured and configured to analyze for generating a motion trajectory of the hands.

When the processor 110 provides the rehabilitation instruction image and the music to the display 140 and audio derive to display and play, the user may move the first grip 161 and the second grip 162 with the hands according to the rehabilitation instruction image and the music, and the image of the user's hands is captured by the image capture device 120 and transmitted to the processor 110 for analyzing and feedback. The display 140 may be any screen that may display images such as a screen of a computer, a television, a panel, or a phone, and the audio device 150 may be an audio playback device such as a stereo or headphones, which is not limited thereto.

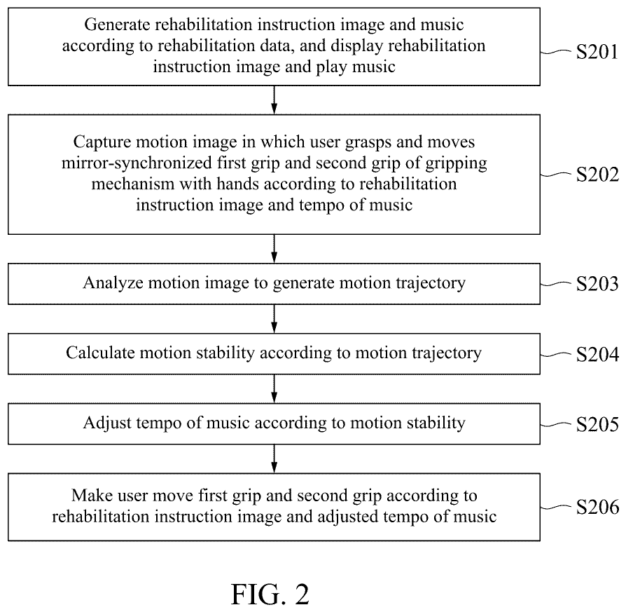

FIG. 2 is a flowchart of a mirror-synchronized rehabilitation method for upper limbs 200 in accordance with some embodiments of the present disclosure. According to FIG. 1 and FIG. 2, the detailed explanation of the mirror-synchronized rehabilitation system for upper limbs 100 is described as following.

First, Step S201 is performed. The rehabilitation instruction module 111 of the processor 110 generates the rehabilitation instruction image and the music according to the rehabilitation data, and transmits them to the display 140 and the audio device 150 respectively to display the rehabilitation instruction image and play the music. The rehabilitation data may include: user data such as rehabilitation history, medical records or upper limb motor ability data, and rehabilitation instruction data, music data and tempo data. The rehabilitation instruction data includes shape patterns with varying complexities, the music data includes music tracks with different preset tempo, and the tempo data includes the corresponding relationship between different tempo speeds or rhythms in different music styles and user rehabilitation conditions.

Due to the variety of the upper limb motor ability and the rehabilitation stage of each user, the rehabilitation instruction module 111 may read the user data in the rehabilitation database 130 to generate the rehabilitation instruction image and the music correspondingly according to the rehabilitation instruction data, the music data and the tempo data. For example, the shape with appropriate complexity is selected from the rehabilitation instruction data as the rehabilitation instruction image, and the music with appropriate tempo is selected or the preset tempo of the music is adjusted correspondingly according to the music data and the tempo data to provide the rehabilitation instruction image and the music which match the user's rehabilitation condition. In addition, in one embodiment, the processor 110 may generate the rehabilitation instruction image and the music according to the user setting.

After displaying the rehabilitation instruction image and playing the music, Step S202 is performed. The image capture device 120 captures the motion image in which the user grasps and moves the first grip 161 and second grip 162 mirror-synchronized of the gripping mechanism 160 with hands according to the rehabilitation instruction image and the tempo of the music. Then Step S203 is performed to transmit the motion image to the processor 110 and generate the corresponding motion trajectory with the analysis feedback module 112. In one embodiment, the motion trajectory may be also displayed in the rehabilitation instruction image after generated. The detailed explanation of the movement of the user's hands according to the rehabilitation instruction image and the tempo of the music and displaying the image on the display 140 correspondingly is described as following.

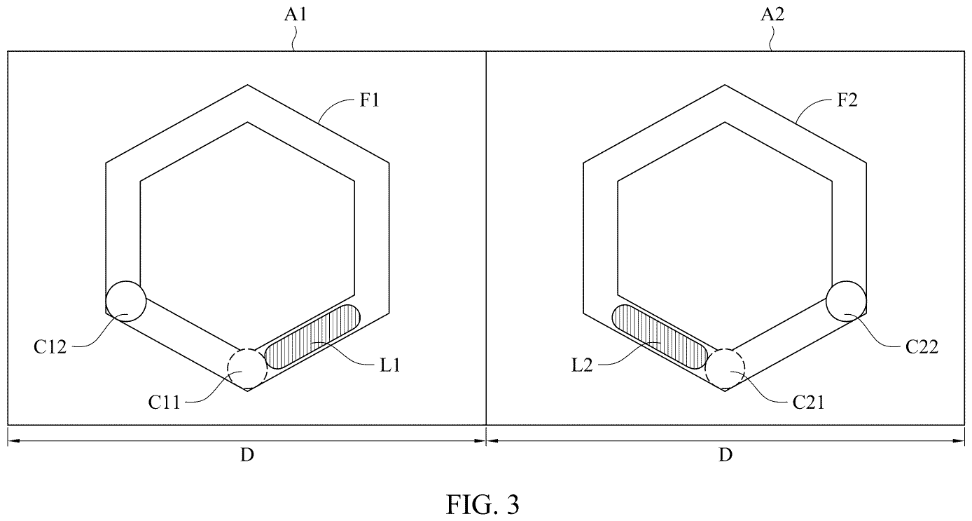

FIG. 3 is a schematic diagram of a rehabilitation instruction image in accordance with some embodiments of the present disclosure. As shown in FIG. 3, an area A1 and an area A2 includes two identical mirror-symmetrical patterns F1 and F2, and there are an indicator point C11 and an indicator point C12 at mirror-symmetrical positions in the pattern F1 and the pattern F2. When the image capture device 120 captures the motion image of the hands and transmits it to the analysis feedback module 112, the analysis feedback module 112 generates the motion trajectories L1 and L2 correspondingly and transmits them to the rehabilitation instruction module 111 for displaying in the rehabilitation instruction image, in which the motion trajectory L1 is corresponding to the movement of the left hand and the motion trajectory L2 is corresponding to the movement of the right hand, and the area A1 and the area A2 are the moving range of the motion trajectory L1 and the motion trajectory L2 respectively. Here, the user's movement goal is to grasp the first grip 161 and the second grip 162 and move following the tempo of the music so that the corresponding motion trajectories L1 and L2 in the rehabilitation instruction image contact the indicator points C11 and C21 in the patterns F1 and F2 respectively on the right tempo.

Taking the motion trajectory L1 corresponding to as an example, when the motion trajectory L1 contacts the indicator point C11, the indicator point C11 disappears and the indicator point C12 appears at another position on the pattern F1 along the original moving direction so that the user has to move the first grip 161 and enable the motion trajectory L1 to contact the indicator point C12. In other words, the appearance order is the indicator point C11, the indicator point C12, and the user has to move the first grip 161 following the appearance order and enable the motion trajectory L1 to contact the indicator points C11 and C12.

For the trajectory L2 corresponding to the right hand, the user also has to move the second grip 162 and enable the motion trajectory L2 to contact the indicator points C21 and C22 in order. In the embodiment, due to the mirror-synchronization of the first grip 161 and the second grip 162, the first grip 161 and the second grip 162 may contact the indicator points C11 and C21 simultaneously under the operation of the user, and then are moved simultaneously and contact the indicator points C12 and C22. In addition, in the embodiment, the pattern F1 and the pattern F2 are hexagons in FIG. 3, which may also be stars, triangles, or other shapes with varying complexity. The shape, the number and the position where the indicator points C11, C12, C21, and C21 appear may be adjusted according to the difficulty and not limited thereto.

In addition, the analysis feedback module 112 determines whether the motion trajectories L1 and L2 contact the indicator points C11 and C21. Taking the motion trajectory L1 and the indicator point C11 as an example, a method of determination is to set a preset percentage value for the edge distance between the trajectory L1 and the indicator point C11 when the width of the area A1 is width D, and determine the motion trajectory L1 contacts the indicator point C11 when the edge distance is less than 1%˜3% of the width D, and then make the indicator point C11 to disappear and the indicator point C21 to appear. Or, in another embodiment, the indicator for determining whether there is contact may also be when the pixel ratio of the trajectory L1 within the circle of the indicator point C11 is greater than a preset ratio. As long as it may be used to determine whether the motion trajectory L1 contact the indicator point C11, it is not limited thereto.

Furthermore, when analyzing the movement of the motion trajectories L1 and L2 and/or determining they contact the indicator points C11 and C21, the analysis feedback module 112 may receive the corresponding sound such as long sound when moving and beep sound when contacting from the rehabilitation database 130 and play. In addition, in one embodiment, with a wristband with vibration feedback wear by the user or a vibration feedback device installed on the gripping mechanism 160, when the user moves the gripping mechanism 160 and contact to the indicator points C11 and C21 correspondingly, the user may hear the feedback sound and feel the vibration feedback at the same time.

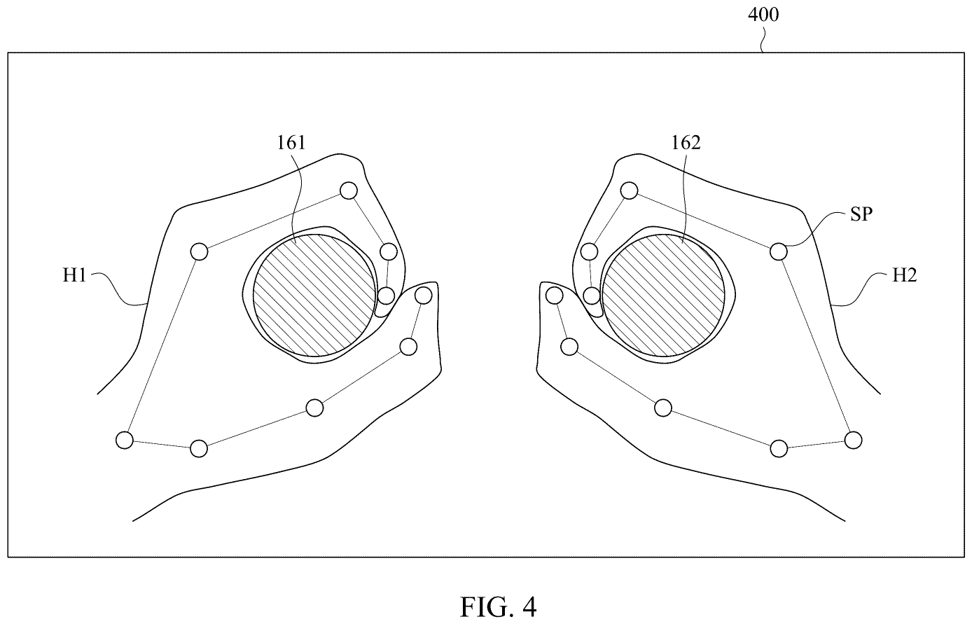

The method the analysis feedback module 112 to generate the trajectories L1 and L2 correspondingly is to analyze the motion image of the user's hands with a skeleton detection model. FIG. 4 is a schematic diagram of performing a skeleton detection on the motion image 400 with a skeleton detection model in accordance with some embodiments of the present disclosure. As shown in FIG. 4, the image capture device 120 captures the motion image 400 of the user's left hand H1 grasping the first grip 161 and the user's right hand H2 grasping the second grip 162, and transmits the motion image 400 to the skeleton detection model of the analysis feedback module 112 to perform the skeleton detection for detecting key points SP corresponding to the hands. The key points SP are located at joints of the palm and fingertips, and the relationship of the key points SP may be obtained by connecting lines.

The training of the skeleton detection model is to use images of varying gestures such as bending and moving any finger of the palm, making a fist, spreading, tapping, grabbing for enabling the skeleton detection model to find joints of the palm and/or back of the hand, with which the analysis feedback module 112 analyzes the motion image 400. As long as the skeleton detection model may find the two-dimensional key points SP of the hands, the types of machine learning model used is not limited in the disclosure. In addition, in one embodiment, the user may wear a wearable inertial measurement unit to obtain the three-dimensional key points SP of hands by measuring three-axis attitude angles and acceleration of the hand movement for more comprehensive hand motion sensing.

After obtaining the key points SP by the skeleton detection model, the motion trajectories L1 and L2 are generated with the movements of the key points SP. In one embodiment, the index fingers of the hands point upwards when the user grasping the first grip 161 and the second grip 162, so that the image capture device 120 is installed at the location where may shoot the entire movement of the index fingers. The analysis feedback module 112 is configured to use the finger movement trajectories generated based on the movement of the key points SP corresponding to the index fingers of the left hand H1 and the right hand H2 as the motion trajectories L1 and L2. However, as long as it may be used to detect the movement of the left hand H1 and the right hand H2, other fingers or more key points SP of the hands may be used as the detection target, which is not limited thereto.

After the motion image of the hands movement is analyzed to generate the motion trajectories L1 and L2, Step S204 is performed. The analysis feedback module 112 calculates a motion stability of the user's hands according to the motion image, in which the motion stability is used for determining whether the user may complete the movement steadily when trying to move following the indicator points C11 and C21 on the tempo, so as to evaluate the upper limb motor ability for the user. Next, Step S205 is performed. The rehabilitation instruction module 111 adjusts the tempo of the music according to the evaluation result of the motion stability of the user which is evaluated by the analysis feedback module 112. For example, the tempo of the music is adjusted faster when the motion stability is high and the tempo of the music is adjusted faster when the motion stability is low. Then Step S206 is performed in which the user may move the first grip 161 and the second grip 162 according to the rehabilitation instruction image and the adjusted tempo of the music.

The analysis feedback module 112 analyzes the motion trajectories L1 and L2 generated by the user moving the hands according to the rehabilitation instruction images and the tempo many times to calculate the motion stability of the user. For example, in one embodiment, the similarity of the motion trajectories is calculated with Euclidean distance method as the motion stability of the user, which is explained with the example of the left hand H1 and its corresponding motion trajectory L1 below.

After detecting the key points SP by the analysis feedback module 112, the two-dimensional coordinates of the key points SP over continuous time are used as the motion trajectory L1. After the left hand H1 drawing the pattern F1 for three times according to the rehabilitation instruction image, the corresponding motion trajectories L1, motion trajectories L1_{A}, L1_{B}, and L1_{C}, for each time are generated. The motion trajectories L1_{A}, L1_{B}, and L1_{C} are represented by Equation (1) to (3):

$$L {1}_{A} = \{ {A}_{1} , {A}_{2} , … , {A}_{Q} \} , {A}_{i} = ( {x}_{{A}_{i}} , {y}_{{A}_{i}} ) ; \qquad ( 1 )$$

$$L {1}_{B} = \{ {B}_{1} , {B}_{2} , … , {B}_{Q} \} , {B}_{i} = ( {x}_{{B}_{i}} , {y}_{{B}_{i}} ) ; and \qquad ( 2 )$$

$$L {1}_{C} = \{ {C}_{1} , {C}_{2} , … , {C}_{Q} \} , {C}_{i} = ( {x}_{{C}_{i}} , {y}_{{C}_{i}} ) , \qquad ( 3 )$$

where the motion image is used as the XY-plane, Aᵢ, Bᵢ, and Cᵢ are the coordinates at the time i, and the motion trajectories L1_{A}, L1_{B}, and L1_{C} include Q coordinates respectively.

After the motion trajectories L1_{A}, L1_{B}, and L1_{C} are obtained, the average Euclidean distance between any two trajectories are calculated with Equation (1) to (3):

$${D}_{A B} = \frac{1}{N} {\sum }_{i = 1}^{N} \sqrt{{( {x}_{{A}_{i}} - {x}_{{B}_{i}} )}^{2} + {( {y}_{{A}_{i}} - {y}_{{B}_{i}} )}^{2}} ; \qquad ( 4 )$$

$${D}_{A C} = \frac{1}{N} {\sum }_{i = 1}^{N} \sqrt{{( {x}_{{A}_{i}} - {x}_{{C}_{i}} )}^{2} + {( {y}_{{A}_{i}} - {y}_{{C}_{i}} )}^{2}} ; and \qquad ( 5 )$$

$${D}_{B C} = \frac{1}{N} {\sum }_{i = 1}^{N} \sqrt{{( {x}_{{B}_{i}} - {x}_{{C}_{i}} )}^{2} + {( {y}_{{B}_{i}} - {y}_{{C}_{i}} )}^{2}} , \qquad ( 6 )$$

where D_{AB}, D_{AC}, D_{BC} are the average Euclidean distances between the motion trajectories L1_{A} and L1_{B}, L1_{A} and L1_{C}, and L1_{B} and L1_{C} respectively, and N is the number of timer the left hand H1 draws the pattern F1, which is N=3 in the embodiment.

Next, the average Euclidean distances are converted into similarity percentages by Equation (7) to (9):

$${S}_{A B} = 100 \% \times ( 1 - \frac{{D}_{A B}}{{D}_{max}} ) ; \qquad ( 7 )$$

$${S}_{A C} = 100 \% \times ( 1 - \frac{{D}_{A C}}{{D}_{max}} ) ; and \qquad ( 8 )$$

$${S}_{B C} = 100 \% \times ( 1 - \frac{{D}_{B C}}{{D}_{max}} ) , \qquad ( 9 )$$

where S_{AB}, S_{AC}, S_{BC} are the similarity percentages between the motion trajectories L1_{A} and L1_{B}, L1_{A} and L1_{C}, and L1_{B} and L1_{C} respectively, and Dₘₐₓ is the max distance within the trajectory range which may be obtained from trajectory bounding box diagonal.

Finally, the average of S_{AB}, S_{AC}, S_{BC} is used as the overall similarity S of the motion trajectories L1_{A}, L1_{B}, and L1_{C} by Equation (10):

$$S = \frac{{S}_{A B} + {S}_{A C} + {S}_{B C}}{3} , \qquad ( 10 )$$

where the overall similarity S is the motion stability of the user in the current evaluation and the analysis feedback module 112 may set a preset stability value, for example, 80%, to obtain the evaluation result by comparing the motion stability and the preset stability value. Specifically, when the motion stability of the user corresponding to multiple movements is determined to be higher than 80%, indicating that the user has high upper limb stability during movement, the tempo of the music may be increased. When the overall similarity S is determined to be lower than 80%, indicating that the user cannot move steadily, the tempo of the music may be decreased, so that the tempo of the music may match the user's rehabilitation condition.

Additionally, besides the methods mentioned above, the motion stability may also be obtained with other calculation methods, which is not limited thereto. In one embodiment, the analysis feedback module 112 may use other evaluation aspects as the indicator for adjusting the tempo of the music, for example, the speed at which the motion trajectory completely moves to form a pattern, a completion rate within a specific time period, or a synchronization rate with the tempo of the music. In addition, it may also use a machine learning model to determine whether the user's empowerment phase during rehabilitation is initial or advanced according to user's movement evaluation result, and decide the feedback according to the phase.

The method for adjusting the tempo of the music by the rehabilitation instruction module 111 is to choose tempo with different speed corresponding to different rehabilitation condition according to the user's movement evaluation result evaluated by the analysis feedback module 112, or to increase or decrease the original tempo by a fixed ratio to establish a new tempo so as to adjust the original music to be played with new tempo. The music adjustment parameter may also be the sound volume and/or the pitch, for example, the volume may be increased and the pitch may be raised when the user's movement performance is poor. In one embodiment, the rehabilitation instruction module 111 may also generate patterns with higher complexities and change the numbers or position of the indicator points C11 and C21 according to user's movement evaluation result evaluated by the analysis feedback module 112 in response to the user's rehabilitation condition.

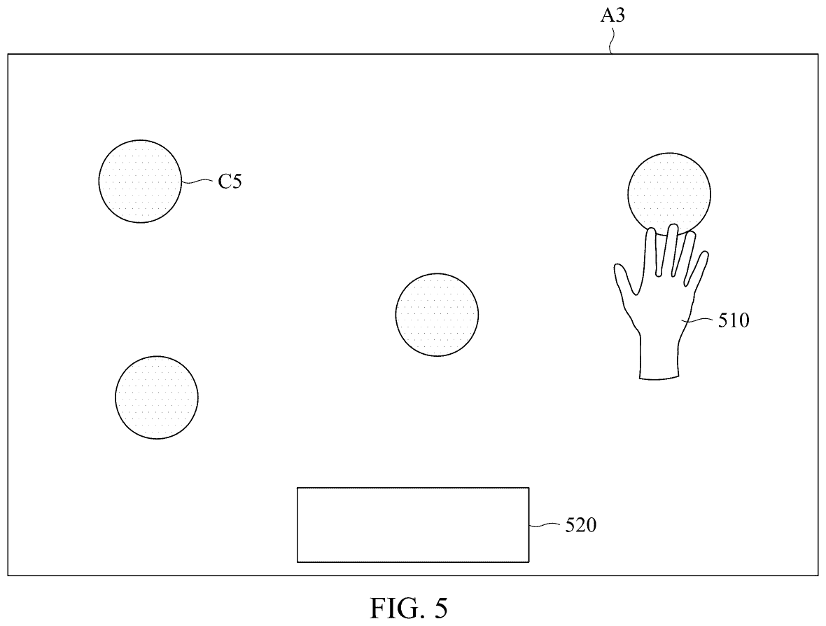

In addition, in one embodiment, the rehabilitation instruction module 111 may also generate another rehabilitation instruction image. FIG. 5 is a schematic diagram of a rehabilitation instruction image in accordance with some embodiments of the present disclosure. As shown in FIG. 5, the rehabilitation instruction image includes an area A3, and the area A3 includes an icon 510, an icon 520 and multiple indicator points C5 in which the icon 510 may be a hand shape and move within the area A3. The interaction of the rehabilitation instruction image with other components in the mirror-synchronized rehabilitation system for upper limbs 100 is explained as following.

In the embodiment, the user may move the palm within the range that the image capture device 120 may capture, and make gestures such as spreading the palm, grabbing, continuously moving the fist, and opening the palm again. When the image capture device 120 captures the palm motion image, it is transmitted to the analysis feedback module 112, which analyzes the motion image with the skeleton detection model, detects the current user's gesture and generates the corresponding motion trajectory to be displayed in the rehabilitation instruction image. In the embodiment, when the icon 510 is in the shape of a hand, the icon 510 may make the same gesture and movement as the user's current motion.

Here, the user's goal is to grab the indicator point C5 to the position of the icon 520 through the icon 510, in which the indicator point C5 may be a pattern of vegetables, fruits, daily necessities, etc., and the icon 520 may be a shopping basket pattern, so that the user may easily simulate the shopping scene to perform the action. Specifically, the method of operation is, for example, when the distance between the open palm gesture of the icon 510 and the indicator point C5 is less than a preset distance, the analysis feedback module 112 determines that the icon 510 is in contact with the indicator point C5, and when the icon 510 performs a first gesture at the indicator point C5, the center of the icon 510 is bound to the indicator point C5, and then the user continues to move the first to make the icon 510 drag the indicator point C5 correspondingly, and the user opens the palm again to release the binding between the icon 510 and the indicator point C5 so that the indicator point C5 stays at the release position.

The analysis feedback module 112 may determine the user's gesture by analyzing and finding the key point coordinates of the thumb and little finger of the user's palm, and then calculating the distance between the two fingers, for example, calculating the Euclidean distance between the two fingers. When the finger distance is less than a grasping distance, it is determined as the first gesture, and when it is greater than the grasping distance, it is determined as an open palm gesture. The key points corresponding to other fingers may also be selected for determination as needed. The motion trajectory here may be the finger movement trajectory of any finger selected as the motion trajectory of the palm as needed. In one embodiment, the gesture may not be specifically identified, but the user may use the gripping mechanism 160 to move and detect the movement of the corresponding motion trajectory and its distance from the indicator point C5 to determine the grasping and dragging of the indicator point C5. It may also be designed to be performed mirror-synchronized as in FIG. 3.

When the analysis feedback module 112 determines that the final position of the indicator point C5 is the position of the icon 520, it means that the user has successfully dragged the indicator point C5 to the target position. Therefore, the corresponding sound such as the score sound effect may be obtained from the rehabilitation database 130 and played. In the embodiment, the rehabilitation level of the user may be determined by the number of the indicator points C5 successfully moved and the speed of moving, and the difficulty is adjusted as feedback, such as increasing the number of indicator points C5, making the indicator points C5 and/or the icon 520 start to move, or even increasing the number of indicator points C5 and making the indicator points C5 and/or the icon 520 move faster, etc., to increase the difficulty. In one embodiment, it may also be performed with the adjustment of the tempo of the music.

In another embodiment, the mirror-synchronized rehabilitation system for upper limbs 100 may also be used for mirror-synchronized training, so that the user performs actions within the shooting range of the image capture device 120, and the analysis feedback module 112 detects the user's movements and displays the mirror image of the movements in the rehabilitation instruction image. For example, when the user's left hand is the affected limb and the right hand is the healthy limb, when the user raises the right hand, the user or virtual character image displayed in the rehabilitation instruction image will raise the left hand, so as to use the image to encourage the user to raise the left hand correspondingly to achieve the effect of promoting training. In addition, the embodiment may also be combined with any of the above embodiments to provide rehabilitation for the user, for example, while the user performs rehabilitation exercises or grasping training following the music tempo and the indicator points, the display 140 displays the user's mirrored movements.

With the mirror-synchronized rehabilitation system for upper limbs 100 in the disclosure, the user may grasp the first grip 161 and the second grip 162 of the gripping mechanism 160, so that both hands may drive each other to achieve the effect of bilateral balance training, especially when one hand is the affected limb, the other hand may drive the affected limb for training, and the combination of the rehabilitation instruction image and the music tempo may add fun and challenge to the rehabilitation. The feedback mechanism of the mirror-synchronized rehabilitation system for upper limbs 100 may also make the rehabilitation more in line with the needs of different users in different rehabilitation conditions. In addition, the mirror-synchronized rehabilitation system for upper limbs 100 utilizes the skeleton detection model to detect the user's movements and the corresponding rehabilitation training plan, and may also provide more diverse and effective rehabilitation methods.

It will be apparent to those skilled in the art that various modifications and variations can be made to the structure of the disclosure without departing from the scope or spirit of the disclosure cover modifications and variations of this disclosure provided they fall within the scope of the following claims.

What is claimed is:

1. A mirror-synchronized rehabilitation system for upper limbs, comprising:
a display configured to display a rehabilitation instruction image;
an audio device configured to play music;
a gripping mechanism, comprising mirror-synchronized first and second grips, and configured to enable a user to grasp and move with hands respectively according to the rehabilitation instruction image and a tempo of the music;
an image capture device configured to capture a motion image of the hands;
a rehabilitation database configured to store rehabilitation data; and
a processor, communicatively connected to the display, the audio device, the image capture device, and the rehabilitation database, and comprising:
a rehabilitation instruction module configured to generate the rehabilitation instruction image and the music according to the rehabilitation data; and
an analysis feedback module configured to analyze the motion image to calculate a motion stability of the hands, and the tempo of the music is adjusted by the rehabilitation instruction module according to the motion stability so that the user moves the first and second grips according to the rehabilitation instruction image and the tempo of the music adjusted.

2. The mirror-synchronized rehabilitation system for upper limbs of claim 1, wherein the rehabilitation instruction module adjusts the tempo faster in response to the motion stability higher than a preset stability value, and adjusts the tempo lower in response to the motion stability lower than the preset stability value.

3. The mirror-synchronized rehabilitation system for upper limbs of claim 1, wherein the analysis feedback module analyzes the motion image to generate a motion trajectory correspondingly, and calculates the motion stability according to the motion trajectories generated according to movements of the user.

4. The mirror-synchronized rehabilitation system for upper limbs of claim 3, wherein the analysis feedback module generates the motion trajectory according to the motion image with a skeleton detection model.

5. The mirror-synchronized rehabilitation system for upper limbs of claim 3, wherein the motion trajectory is a finger motion trajectory of at least one finger of the hands of the user.

6. The mirror-synchronized rehabilitation system for upper limbs of claim 3, wherein the rehabilitation instruction image comprises indicator points with an appearance order and the motion trajectory so that the user moves the first and second grips to enable the motion trajectory to contact the indicator points correspondingly.

7. The mirror-synchronized rehabilitation system for upper limbs of claim 6, wherein the user moves the first and second grips to make the motion trajectory correspondingly contact the indicator points following the tempo with the appearance order.

8. The mirror-synchronized rehabilitation system for upper limbs of claim 6, wherein the analysis feedback module is further configured to generate a corresponding sound according to the motion image in response to the user moving the first and second grips, and the sound is played by the audio device.

9. A mirror-synchronized rehabilitation method for upper limbs, comprising:
generating a rehabilitation instruction image and music according to rehabilitation data with a processor;
displaying a rehabilitation instruction image with a display and playing music with an audio device;
capturing a motion image with an image capture device, wherein the motion image comprises that a user grasp and move mirror-synchronized first and second grips, comprised in a gripping mechanism, with hands respectively according to the rehabilitation instruction image and a tempo of the music;
analyzing the motion image to calculate a motion stability of the hands with the processor; and
adjusting the tempo of the music according to the motion stability with the processor so that the user moves the first and second grips according to the rehabilitation instruction image and the tempo of the music adjusted.

10. The mirror-synchronized rehabilitation method for upper limbs of claim 9, wherein the processor adjusts the tempo faster in response to the motion stability higher than a preset stability value, and adjusts the tempo lower in response to the motion stability lower than the preset stability value.

11. The mirror-synchronized rehabilitation method for upper limbs of claim 9, further comprising:
analyzing the motion image to generate a motion trajectory correspondingly, and calculating the motion stability according to the motion trajectories generated according to movements of the user with the processor.

12. The mirror-synchronized rehabilitation method for upper limbs of claim 11, wherein the motion trajectory is generated according to the motion image with a skeleton detection model.

13. The mirror-synchronized rehabilitation method for upper limbs of claim 11, wherein the motion trajectory is a finger motion trajectory of at least one finger of the hands of the user.

14. The mirror-synchronized rehabilitation method for upper limbs of claim 11, wherein the rehabilitation instruction image comprises indicator points with an appearance order and the motion trajectory so that the user moves the first and second grips to enable the motion trajectory to contact the indicator points correspondingly.

15. The mirror-synchronized rehabilitation method for upper limbs of claim 14, further comprising:
generating a corresponding sound with the processor according to the motion image in response to the user moving the first and second grips, and the sound is played by the audio device.
